(19) United States
(12) Patent Application Publication
(10) Pub. No.: US 2025/0376223 A1
(43) Pub. Date: Dec. 11, 2025

(54) TAILGATE STOPPER PANEL

(71) Applicant: Toyota Motor Engineering & Manufacturing North America, Inc., Plano, TX (US)

(72) Inventor: Tarakorn Soonthornwinate, Plymouth, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/737,870

(22) Filed: Jun. 7, 2024

(51) Int. Cl. B62D 33/027

(52) U.S. Cl. CPC B62D 33/0273

(57) ABSTRACT

A vehicle includes a tailgate assembly including a primary gate panel and an inner gate panel. The primary gate panel includes a recess, a proximal end, and a distal end. The inner gate panel includes an inner gate positioned in the recess of the primary gate panel. The inner gate panel is slidingly moveable with respect to the primary gate panel along a vehicle longitudinal direction between a stowed position and an intermediate position and is pivotable with respect to the primary gate panel between the intermediate position and the fully opened position. In the stowed position the inner gate panel is co-planar with the primary gate panel. In the fully opened position, the inner gate panel is substantially perpendicular with respect to the primary gate panel.

### BACKGROUND

### 1. Field

The various aspects and embodiments described herein relate generally to vehicle tailgates and, in particular, to a tailgate stopper panel.

### 2. Description of the Related Art

Some vehicles, such as pickup trucks, have truck beds for carrying loads and tailgates for retaining the loads in or on the beds. The tailgate is generally moveable between a closed position, with the tailgate in an up or vertical position, and an open position, with the tailgate in a down or horizontal position. When a tailgate is in an up or vertical orientation, the tailgate serves to confine the load to the truck bed area. The tailgate is generally lowered in order to load and unload the truck bed. There may be times, however, when the length of a load is greater than the length of the truck bed. In such a case, the tailgate may be left in a lowered or horizontal orientation when the lengthy load is carried. A problem exists, however, with the tailgate in the lowered position. That is, the load is no longer confined by a vertically oriented tailgate. In this respect, it would be desirable if a device were provided that helped confine a lengthy load on a truck bed even though the tailgate is in a lowered or open position.

### SUMMARY

In general, one aspect of the subject matter described in this disclosure may be embodied in a vehicle. The vehicle includes a tailgate assembly configured to enclose a truck bed. The tailgate assembly includes a primary gate panel and an inner gate panel. The primary gate panel includes a recess, a proximal end, and a distal end. The inner gate panel is configured to be positioned in the recess of the primary gate panel. The inner gate panel is slidingly moveable with respect to the primary gate panel along a vehicle longitudinal direction between a stowed position and an intermediate position. The inner gate panel is pivotable with respect to the primary gate panel between the intermediate position and a fully opened position. In the stowed position, the inner gate panel is co-planar with the primary gate panel. In the fully opened position, the inner gate panel is substantially perpendicular with respect to the primary gate panel.

In another aspect, the subject matter may be embodied in a tailgate assembly for a vehicle. The tailgate assembly includes a primary gate panel and an inner gate panel. The primary gate panel includes a recess, a proximal end, and a distal end. The inner gate panel includes an inner gate positioned in the recess of the primary gate panel. The inner gate panel is slidingly moveable with respect to the primary gate panel between a stowed position and an intermediate position. The inner gate panel is pivotable with respect to the primary gate panel between the intermediate position and a fully opened position. In the stowed position, the inner gate panel is co-planar with the primary gate panel. In the fully opened position, the inner gate panel is substantially perpendicular with respect to the primary gate panel.

In another aspect, the subject matter may be embodied in a method of using a tailgate assembly for a vehicle. The method includes transitioning the tailgate assembly of the vehicle from a closed position to an open position. The method further includes translating an inner gate panel of the tailgate assembly with respect to a primary gate panel of the tailgate assembly from a stowed position to an intermediate position. The method further includes rotating the inner gate panel of the tailgate assembly with respect to the primary gate panel of the tailgate assembly from the intermediate position to a fully open position.

In various aspects, the method further includes moving the inner gate panel to extend past a distal end of the primary gate panel in response to (i) translating the inner gate panel with respect to the primary gate panel from the stowed position to the intermediate position, and/or (ii) rotating the inner gate panel with respect to the primary gate panel from the intermediate position to the fully open position.

These and other embodiments may optionally include on or more of the following features.

In various aspects, in the fully opened position, the inner gate panel rotates past the distal end of the primary gate panel.

In various aspects, the primary gate panel further includes a first cavity and a second cavity spaced apart from the first cavity. In various aspects, the inner gate panel further includes a first hinge arm configured to be received by the first cavity and a second hinge arm configured to be received by the second cavity.

In various aspects, the inner gate panel is configured to translate with respect to the primary gate panel between the stowed position and an extended position such that the inner gate panel has a floating axis of rotation.

In various aspects, a hinge rod extends between and to the first hinge arm and the second hinge arm whereby the inner gate panel is slidingly and rotatably coupled to the primary gate panel.

In various aspects, an elongated slot is disposed in the primary gate panel. The elongated slot can extend between and to the first cavity and the second cavity. The hinge rod can be moveable within the elongated slot so as to allow the inner gate panel to translate with respect to the primary gate panel between the stowed position and the extended position.

In various aspects, the inner gate panel includes a first side and a second side opposite the first side, the first hinge arm and the second hinge arm extend from the first side, and the first side of the inner gate panel is configured to contact the distal end of the primary gate panel to stop the inner gate panel from rotating past the fully opened position.

In various aspects, the inner gate panel includes a first side and a second side opposite the first side, the first hinge arm and the second hinge arm extend from the first side, and the first hinge arm and the second hinge arm are configured to contact the primary gate panel to stop the inner gate panel from rotating past the fully opened position.

In various aspects, the first hinge arm and the second hinge arm are each L-shaped hinge arms.

### BRIEF DESCRIPTION OF THE DRAWINGS

Other apparatuses, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a perspective view of a vehicle according to an aspect of the present disclosure;

FIG. 2A illustrates a tailgate assembly in an open position and having an inner gate panel in a stowed position according to an aspect of the present disclosure;

FIG. 2B illustrates the tailgate assembly of FIG. 2A with the inner gate panel in a fully open position according to an aspect of the present disclosure;

FIG. 3 illustrates a side view of the vehicle of FIG. 1 with the tailgate assembly in an open position and the inner gate panel in a fully open position according to an aspect of the present disclosure;

FIG. 4 illustrates an assembly view of a tailgate assembly according to an aspect of the present disclosure;

FIG. 5A is a section view of the tailgate assembly of FIG. 4 with the inner gate panel in a stowed position according to an aspect of the present disclosure;

FIG. 5B is a section view of the tailgate assembly of FIG. 4 with the inner gate panel in an extended position according to an aspect of the present disclosure;

FIG. 5C is a section view of the tailgate assembly of FIG. 4 with the inner gate panel in a fully open position according to an aspect of the present disclosure; and

FIG. 6 is a flow diagram of an example process of using a tailgate assembly for a vehicle according to an aspect of the present disclosure.

### DETAILED DESCRIPTION

Disclosed herein are apparatus, systems, and methods for implementing a tailgate assembly for a vehicle. The tailgate assembly includes a multi-panel arrangement including a primary gate panel pivotally coupled to the vehicle and an inner gate panel pivotally coupled to the primary gate panel. The inner gate panel is configured to be deployed in a fully open (i.e., deployed) or vertical position when the primary gate panel is in an open or horizontal position so as to increase the usable length of the vehicle bed while simultaneously confining a load to a vehicle cargo area such as a truck bed.

The apparatus, systems, and methods described herein eliminate the need for linkages which can block a path during loading/unloading of a vehicle cargo area and/or which can be accidentally stepped on or otherwise contacted which can cause the inner gate panel to inadvertently close or can cause injury to a user (e.g., a user can trip over the linkages). For instance, the inner gate panel can be pivotally coupled to the primary gate panel via one or more hinge arms that lay substantially flush with, or slightly below, a work surface of the primary gate panel when the inner gate panel is deployed. In various aspects, the inner gate panel is configured to translate toward a distal end of the primary gate panel when being deployed. In this manner, the inner gate panel can clear the distal end of the primary gate panel to rotate to a fully opened position.

As used herein, the term “floating axis” means the axis of rotation of a first body, such as an inner gate panel of a tailgate assembly, is not fixed in position with respect to a second body, such as a primary gate panel of the tailgate assembly, to which the first body is rotationally coupled, such that the axis of rotation may make some movement or translational movement in one or more directions essentially orthogonal to the axis of rotation. More particularly, the inner gate panel and axis of rotation thereof can translate toward a distal end of the primary gate panel to rotate the inner gate panel to the fully open position. Stated differently, translating the inner gate panel and axis of rotation thereof with respect to the primary gate panel when deploying the inner gate panel can provide sufficient clearance for the inner gate panel to rotate to the fully open position.

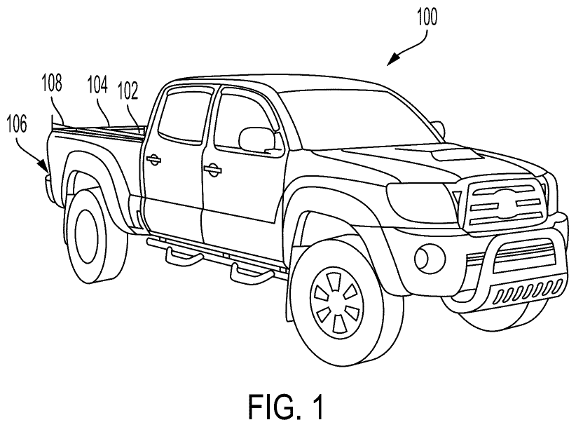

FIG. 1 illustrates a perspective view of a vehicle 100 to be used with a tailgate system, in accordance with various aspects. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a pick-up truck, an SUV, a UTV, a minivan, a stain wagon, or another other motor or battery driven vehicle. For example, the vehicle 100 may be an electric vehicle, a hybrid vehicle, a plug-in hybrid vehicle, a fuel cell vehicle, or any other type of vehicle that includes a motor/generator. FIG. 1 depicts a pick-up truck by example. The vehicle 100 may be an autonomous or semi-autonomous vehicle having self-driving capabilities. The vehicle 100 may have a truck bed 102 enclosed by a tailgate 104 (also referred to herein as a tailgate assembly) from a rear end 106. The truck bed 102 may have an open top or a closed top. The truck bed 102 may be suitable to store and transport cargo. The truck bed 102 may accommodate cargo that has a length longer than a length 108 of the truck bed 102. For instance, the cargo may extend out from the tailgate 104. In various aspects, the tailgate 104 may enclose a trunk. The tailgate 104 may be manufactured from metal, glass, plastic, a composite material, and/or wood.

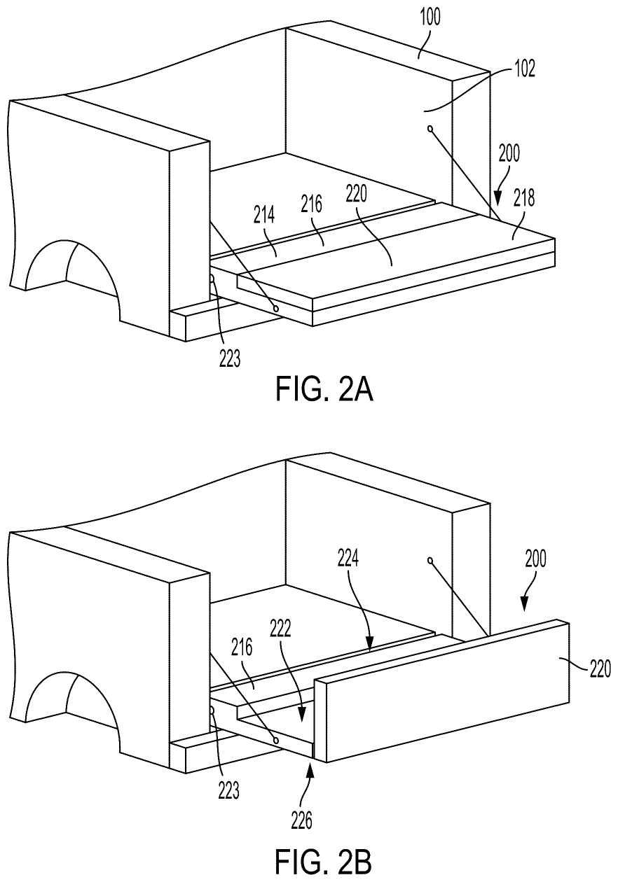

FIGS. 2A and 2B show views of a tailgate assembly 200 coupled to the vehicle 100 in an open position. The tailgate assembly 200 can be similar to the tailgate 104 of FIG. 1 in accordance with various aspects. The tailgate assembly 200 includes a primary gate assembly 214 that includes a primary gate panel 216, and an inner gate assembly 218 that includes an inner gate panel 220. In FIG. 2A, the inner gate panel 220 is in a closed or stowed position and is co-planar with the primary gate panel 216. In FIG. 2B, the inner gate panel 220 is in a fully open or deployed position and is substantially perpendicular with respect to the primary gate panel 216. The primary gate panel 216 contains a recess 222 into which the inner gate panel 220 pivots when being closed. The inner gate panel 220 can include a grasping area that may grasped by the hand of a user to pivot or otherwise move the inner gate panel 220 to an open position. In various aspects, the inner gate panel 220 can be moved using an automated process, for example using one or more electric motors.

In various aspects, the primary gate panel 216 is attached to the vehicle 100 on a pivotal connection, e.g., a hinge mechanism 223, which permits rotary motion of the tailgate assembly 200 between the closed position and the open position and vice versa. The primary gate panel 216 includes a proximal end 224 and a distal end 226. The primary gate panel 216 can be pivotally coupled to the vehicle 100 at the proximal end 224. The inner gate panel 220 can extend past the distal end 226 when in the fully open position.

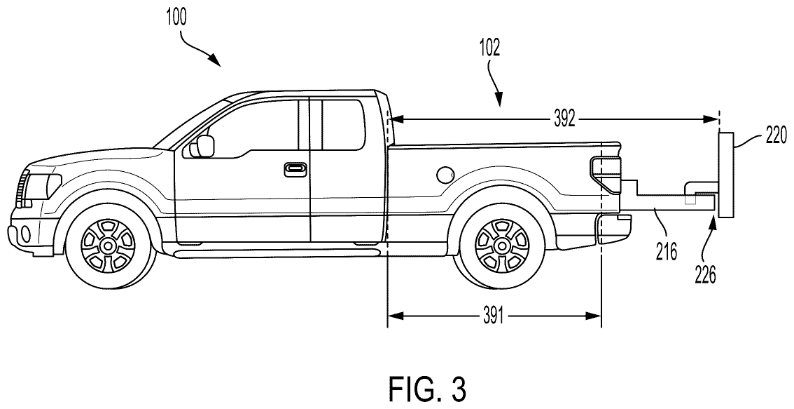

FIG. 3 shows a side view of the tailgate assembly 200 coupled to the vehicle 100 in an open position, and with the inner gate panel 220 in a fully open position, in accordance with various aspects. With the inner gate panel 220 in the fully open position, the inner gate panel 220 acts as a stopper panel to prevent items within the truck bed 102 from sliding or moving rearward. Stated differently, the inner gate panel 220 assists in containing items within the truck bed 102 and forms a wall at the distal end 226 of the primary gate panel 216. When the tailgate assembly 200 is closed, the truck bed 102 can have a first usable dimension 391, as measured along a length of the truck bed 102. For example, the first usable dimension 391 can be measured from a front end of the truck bed 102 to a front end of the tailgate assembly 200 when the tailgate assembly 200 is in a closed position. When the tailgate assembly 200 is open, with the inner gate panel 220 in a fully open position, the truck bed 102 can have a second, extended usable dimension 392, as measured along a length of the truck bed 102. For example, the extended usable dimension 392 can be measured from a front end of the truck bed 102 to a front end of the inner gate panel 220 when the tailgate assembly 200 is in an open position with the inner gate panel 220 in a fully open position. In this manner, the inner gate panel 220 slides outward and effectively extends the usable space of the truck bed 102 from the first dimension 391 to the extended dimension 392. In various aspects, the extended dimension 392 is between 110% and 150% of the first dimension 391.

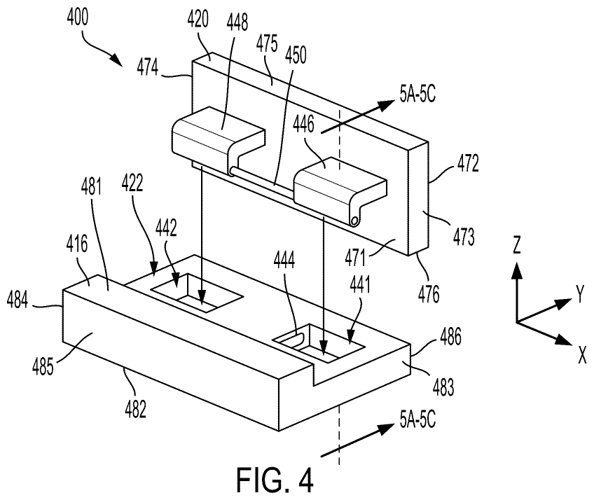

FIG. 4 is an assembly view of a tailgate assembly 400, in accordance with various aspects. The tailgate assembly 200 of FIG. 2A through FIG. 3 can be similar to tailgate assembly 400, in accordance with various aspects. The primary gate panel 416 can include a first cavity 441 and a second cavity 442. The first cavity 441 can be spaced apart from the second cavity 442. The first cavity 441 and the second cavity 442 can be disposed in the recess 422 portion of the primary gate panel 416.

An elongated slot 444 can be disposed in the primary gate panel 416 and extending between and to the first cavity 441 and the second cavity 442. The elongated slot 444 can extend along a first direction (i.e., along the X-direction in FIG. 4) between the first cavity 441 and the second cavity 442. The elongated slot 444 can be elongated along a second direction (i.e., along the Y-direction in FIG. 4) to accommodate translational movement of the inner gate panel 420 with respect to the primary gate panel 416.

The tailgate assembly 400 can further include a first hinge arm 446 and a second hinge arm 448. The first hinge arm 446 can be spaced apart from the second hinge arm 448. The first hinge arm 446 can be received in the first cavity 441. The second hinge arm 448 can be received in the second cavity 442. The first hinge arm 446 and the second hinge arm 448 can each be L-shaped hinge arms.

The first hinge arm 446 can be pivotally coupled to the primary gate panel 416 at the first cavity 441. The second hinge arm 448 can be pivotally coupled to the primary gate panel 416 at the second cavity 442. The tailgate assembly 400 can further include a hinge rod 450 extending between and to the first hinge arm 446 and the second hinge arm 448, whereby the inner gate panel 420 is slidingly and rotatably coupled to the primary gate panel 416. The hinge rod 450 can be received in, and extend through, the elongated slot 444.

The inner gate panel 420 can include a first side 471 and a second side 472 opposite the first side 471. The first hinge arm 446 and the second hinge arm 448 can extend from the first side 471. The first side 471 and the second side 472 can extend in a first direction (i.e., along the X-direction in FIG. 4) between and to a first end 473 of the inner gate panel 420 and a second end 474 of the inner gate panel 420. The first side 471 and the second side 472 can extend in a second direction (i.e., along the Z-direction in FIG. 4) perpendicular to the first direction between and to a third end 475 of the inner gate panel 420 and a fourth end 476 of the inner gate panel 420.

The primary gate panel 416 can include a first side 481 and a second side 482 opposite the first side 481. The first cavity 441 and the second cavity 442 can be disposed in the first side 481. The first side 481 and the second side 482 can extend in a first direction (i.e., along the X-direction in FIG. 4) between and to a first end 483 of the primary gate panel 416 and a second end 484 of the primary gate panel 416. The first side 481 and the second side 482 can extend in a second direction (i.e., along the Y-direction in FIG. 4) perpendicular to the first direction between and to a third end 485 (also referred to herein as a proximal end) of the primary gate panel 416 and a fourth end 486 (also referred to herein as a distal end) of the primary gate panel 416.

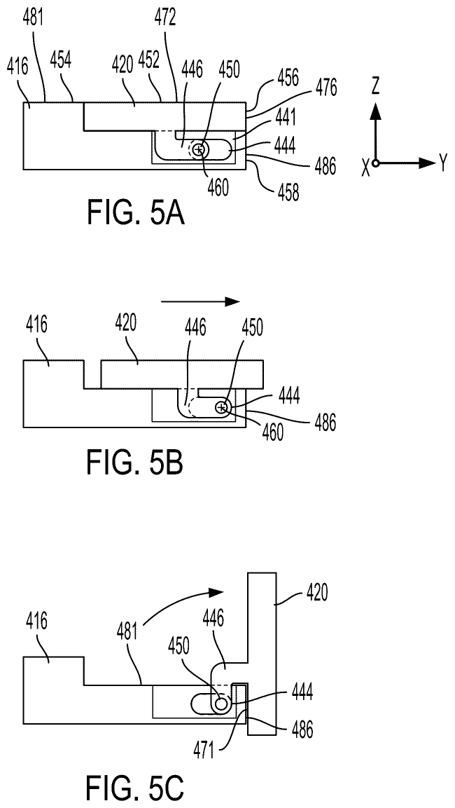

FIG. 5A shows the inner gate panel 420 in a stowed position. In the stowed position, the inner gate panel 420 can be co-planar with the primary gate panel 416. In the stowed position, an exposed surface 452 at the second side 472 of the inner gate panel 420 can be substantially flush with an exposed surface 454 of the first side 481 of the primary gate panel 416. In the stowed position, an exposed distal surface 456 at the fourth end 476 of the inner gate panel 420 can be substantially flush with an exposed distal surface 458 of the fourth end 486 of the primary gate panel 416. In the stowed position, the first hinge arm 446 can be moved toward the fourth end 486 of the primary gate panel 416 within the first cavity 441. In the stowed position, the second hinge arm 448 can be moved toward the fourth end 486 of the primary gate panel 416 within the second cavity 442.

FIG. 5B shows the inner gate panel 420 in an extended position, with the inner gate panel 420 translated aft ward in a vehicle longitudinal direction (i.e., the Y-direction in FIG. 5A), with respect to the primary gate panel 416, toward the distal end 486 of the primary gate panel 416. The first hinge arm 446 and the second hinge arm 448 can translate together with the inner gate panel 420. The hinge rod 450 can translate together with the first hinge arm 446, the second hinge arm 448, and the inner gate panel 420. Accordingly, the axis of rotation 460 of the inner gate panel 420 can be a floating axis, movable with respect to the primary gate panel 416. The axis of rotation of the inner gate panel 420 can extend along a vehicle lateral direction (i.e., the X-direction of FIG. 5A).

The inner gate panel 420 can translate with respect to the primary gate panel 416 in the vehicle longitudinal direction to provide clearance for the inner gate panel 420 to rotate to the fully open position (see FIG. 5C). In this regard, the width of the elongated slot 444 (e.g., as measured along the Y-direction in FIG. 5A) can be sized so as to accommodate the translating movement of the inner gate panel 420 with respect to the primary gate panel 416. The hinge rod 450 is moveable within the elongated slot 444 so as to allow the inner gate panel 420 to translate with respect to the primary gate panel 416 between the stowed position (see FIG. 5A) and an extended position (see FIG. 5B). The elongated slot 444 can limit translational movement (e.g., sliding movement of the inner gate panel 420) with respect to the primary gate panel 416 in the aft direction (i.e., the positive Y-direction in FIG. 5A). The inner gate panel 420 can slide or otherwise move past the distal end 486 of the primary gate panel 416 as the inner gate panel 420 moves from the stowed position to the extended position.

FIG. 5C shows the inner gate panel 420 in a fully open position. The inner gate panel 420 can rotate about the axis of rotation 460 between the stowed position, the extended position, or a position therebetween and the fully open position. The inner gate panel 420 can rotate past the distal end 486 of the primary gate panel 416 as the inner gate panel 420 rotates to the fully opened position.

In various aspects, the first side 471 of the inner gate panel 420 contacts the fourth/distal end 486 of the primary gate panel 416 to stop the inner gate panel 420 from rotating past the fully opened position. In various aspects, the first hinge arm 446 and the second hinge arm 448 contact the first side 481 of the primary gate panel 416 to stop the inner gate panel 420 from rotating past the fully opened position. In various aspects, the inner gate panel 420 rotates approximately ninety degrees between the stowed position (see FIG. 5A) and the fully open position (see FIG. 5C), wherein the term “approximately” in this regard can only mean±five degrees.

The first hinge arm 446 and the second hinge arm 448 can be substantially flush with the exposed surface 454 of the primary gate panel 416 when the inner gate panel 420 is rotated to the fully open position. The first hinge arm 446 and the second hinge arm 448 can be recessed below the exposed surface 454 of the primary gate panel 416 when the inner gate panel 420 is rotated to the fully open position. In this manner, the first hinge arm 446 and the second hinge arm 448 are out of the path of any cargo in the truck bed. In this regard, the first side 471 of the inner gate panel 420 can act as a stopper surface to contain cargo within the truck bed.

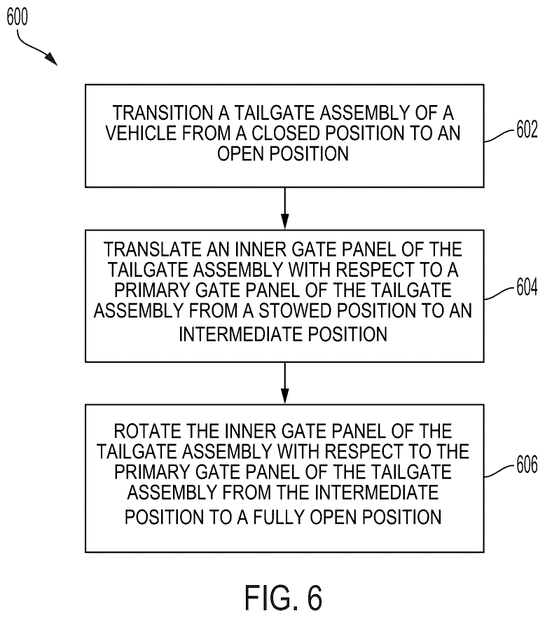

FIG. 6 is a flow diagram of an example process 600 for using a tailgate assembly for a vehicle. For ease of description, the process 600 is described below with reference to FIGS. 1-5C. The process 600 of the present disclosure, however, is not limited to use of the exemplary tailgate systems of FIGS. 1-5C.

The tailgate assembly 200 of the vehicle 100 can be transitioned from a closed position (see FIG. 1) to an open position (see FIG. 2A and FIG. 5A) (602). For example, a user can manually open the tailgate assembly 200 or the tailgate assembly 200 can open via an automated process using one or more electric motors.

The inner gate panel 220 of the tailgate assembly 200 can be translated with respect to a primary gate panel 216 of the tailgate assembly 200 from a stowed position (see FIG. 2A and FIG. 5A) to an intermediate position (see FIG. 5B) (604). For example, a user can manually move the inner gate panel 220 or the inner gate panel 220 can be moved via an automated process using one or more motors.

The inner gate panel 220 of the tailgate assembly 200 can be rotated with respect to the primary gate panel 216 of the tailgate assembly 200 from the intermediate position (see FIG. 5B) to a fully open position (see FIG. 2B, FIG. 3, and FIG. 5C) (606). For example, a user can manually rotate the inner gate panel 220 with respect to the primary gate panel 216 or the inner gate panel 220 can be rotated via an automated process using one or more motors.

In various aspects, the inner gate panel 220 moves to extend past a distal end 226 of the primary gate panel 216 in response to the inner gate panel 220 translating or sliding with respect to a primary gate panel 216 from the stowed position to the intermediate position. In various aspects, the inner gate panel 220 moves to extend past a distal end 226 of the primary gate panel 216 in response to the inner gate panel 220 rotating with respect to the primary gate panel 216 from the intermediate position to the fully open position.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is intended to invoke 35 U.S.C. 112 (f) unless the element is expressly recited using the phrase “means for.”

What is claimed is:

1. A vehicle comprising:
a tailgate assembly configured to enclose a truck bed, the tailgate assembly comprising:
a primary gate panel including a recess, a proximal end, and a distal end; and
an inner gate panel configured to be positioned in the recess of the primary gate panel, the inner gate panel being slidingly moveable with respect to the primary gate panel along a vehicle longitudinal direction between a stowed position and an intermediate position, and the inner gate panel being pivotable with respect to the primary gate panel between the intermediate position and a fully opened position, in the stowed position the inner gate panel is co-planar with the primary gate panel, and in the fully opened position the inner gate panel is substantially perpendicular with respect to the primary gate panel.

2. The vehicle of claim 1, wherein, in the fully opened position, the inner gate panel rotates past the distal end of the primary gate panel.

3. The vehicle of claim 2, wherein:
the primary gate panel further includes a first cavity and a second cavity spaced apart from the first cavity; and
the inner gate panel further includes a first hinge arm configured to be received by the first cavity and a second hinge arm configured to be received by the second cavity.

4. The vehicle of claim 3, wherein the inner gate panel is configured to translate with respect to the primary gate panel between the stowed position and an extended position such that the inner gate panel has a floating axis of rotation.

5. The vehicle of claim 4, further comprising a hinge rod extending between and to the first hinge arm and the second hinge arm whereby the inner gate panel is slidingly and rotatably coupled to the primary gate panel.

6. The vehicle of claim 5, further comprising an elongated slot disposed in the primary gate panel and extending between and to the first cavity and the second cavity, and the hinge rod is moveable within the elongated slot so as to allow the inner gate panel to translate with respect to the primary gate panel between the stowed position and the extended position.

7. The vehicle of claim 3, wherein the inner gate panel includes a first side and a second side opposite the first side, the first hinge arm and the second hinge arm extend from the first side, and the first side of the inner gate panel is configured to contact the distal end of the primary gate panel to stop the inner gate panel from rotating past the fully opened position.

8. The vehicle of claim 3, wherein the inner gate panel includes a first side and a second side opposite the first side, the first hinge arm and the second hinge arm extend from the first side, and the first hinge arm and the second hinge arm are configured to contact the primary gate panel to stop the inner gate panel from rotating past the fully opened position.

9. The vehicle of claim 3, wherein the first hinge arm and the second hinge arm are each L-shaped hinge arms.

10. A tailgate assembly for a vehicle, comprising:
a primary gate panel including a recess, a proximal end, and a distal end; and
an inner gate panel configured to be positioned in the recess of the primary gate panel, the inner gate panel being slidingly moveable with respect to the primary gate panel between a stowed position and an intermediate position, and the inner gate panel being pivotable with respect to the primary gate panel between the intermediate position and a fully opened position, in the stowed position the inner gate panel is co-planar with the primary gate panel, and in the fully opened position the inner gate panel is substantially perpendicular with respect to the primary gate panel.

11. The tailgate assembly of claim 10, wherein, in the fully opened position, the inner gate panel rotates past the distal end of the primary gate panel.

12. The tailgate assembly of claim 11, wherein:
the primary gate panel further includes a first cavity and a second cavity spaced apart from the first cavity; and
the inner gate panel further includes a first hinge arm configured to be received by the first cavity and a second hinge arm configured to be received by the second cavity.

13. The tailgate assembly of claim 12, wherein the inner gate panel is configured to translate with respect to the primary gate panel between the stowed position and an extended position such that the inner gate panel has a floating axis of rotation.

14. The tailgate assembly of claim 13, further comprising a hinge rod extending between and to the first hinge arm and the second hinge arm whereby the inner gate panel is slidingly and rotatably coupled to the primary gate panel.

15. The tailgate assembly of claim 14, further comprising an elongated slot disposed in the primary gate panel and extending between and to the first cavity and the second cavity, and the hinge rod is moveable within the elongated slot so as to allow the inner gate panel to translate with respect to the primary gate panel between the stowed position and the extended position.

16. The tailgate assembly of claim 12, wherein the inner gate panel includes a first side and a second side opposite the first side, the first hinge arm and the second hinge arm extend from the first side, and the first side of the inner gate panel is configured to contact the distal end of the primary gate panel to stop the inner gate panel from rotating past the fully opened position.

17. The tailgate assembly of claim 12, wherein the inner gate panel includes a first side and a second side opposite the first side, the first hinge arm and the second hinge arm extend from the first side, and the first hinge arm and the second hinge arm are configured to contact the primary gate panel to stop the inner gate panel from rotating past the fully opened position.

18. The tailgate assembly of claim 12, wherein the first hinge arm and the second hinge arm are each L-shaped hinge arms.

19. A method of using a tailgate assembly for a vehicle, the method comprising:
transitioning the tailgate assembly of the vehicle from a closed position to an open position;
translating an inner gate panel of the tailgate assembly with respect to a primary gate panel of the tailgate assembly from a stowed position to an intermediate position; and
rotating the inner gate panel of the tailgate assembly with respect to the primary gate panel of the tailgate assembly from the intermediate position to a fully open position.

20. The method of claim 19, further comprising moving the inner gate panel to extend past a distal end of the primary gate panel in response to at least one of:
translating the inner gate panel with respect to the primary gate panel from the stowed position to the intermediate position; or
rotating the inner gate panel with respect to the primary gate panel from the intermediate position to the fully open position.
